(19) United States
(12) Patent Application Publication
(10) Pub. No.: US 2009/0262051 A1
(43) Pub. Date: Oct. 22, 2009

(54) Organic light emitting display device

(76) Inventors: Se-Ho Kim, Yongin-City (KR); Won-Kyu Kwak, Yongin-City (KR); Kwang-Min Kim, Yongin-City (KR)

Correspondence Address: LEE & MORSE, P.C., 3141 FAIRVIEW PARK DRIVE, SUITE 500, FALLS CHURCH, VA, 22042, US

(21) Appl. No.: 12/385,345

(22) Filed: Apr. 6, 2009

(30) Foreign Application Priority Data
Apr. 18, 2008 (KR) 10-2008-0036104

(51) Int. Cl. G09G 3/30

(52) U.S. Cl. 345/80

(57) ABSTRACT

An organic light emitting display device, may include a pixel unit including scan lines, data lines and a plurality of pixels positioned at intersecting portions of the scan lines and the data lines and electrically coupled therebetween, a scan driver adapted to supply scan signals to the scan lines, and a plurality of pads, wherein at least some of the plurality of pads are adapted to supply driving powers and driving signals to the pixel unit and the scan driver, and among the plurality of pads, a plurality of pads supply the same driving power or driving signal to the scan driver.

### BACKGROUND

1. Field

Embodiments relate to an organic light emitting display device, and more particularly, to an organic light emitting display device capable of preventing malfunction of a scan driver and/or an emission control driver.

2. Description of the Related Art

Various flat panel display devices that are lighter in weight and smaller in volume as compared to cathode ray tubes have been developed. Among others, an organic light emitting display device using organic compounds as light emitting materials is particularly excellent in brightness and color purity so that it is spotlighted as a next generation display device.

As organic light emitting display devices may be relatively thin, light and capable of being driven with low power so that it expects to be usefully used in a portable display device, etc.

In general, an organic light emitting display device includes a pixel unit including a plurality of pixels, and a scan driver and a data driver for supplying scan signals and data signals to the pixels.

In active organic light emitting display devices including a compensation circuit compensating for a threshold voltage Vth of a driving transistor, etc., a scan driver is built in a panel for performing a lighting test, etc.

Such a scan driver is supplied with driving powers and/or driving signals from any one side, e.g., from a first terminal or a last terminal.

However, e.g., in a wide area panel having high resolution, a more significant delay (RC delay) and/or voltage drop (IR drop) of driving powers and/or driving signals is likely to be generated. More particularly, e.g., a delay and/or a voltage drop of driving powers and/or driving signals resulting from a built-in scan driver may cause the scan driver may malfunction.

In particular, when the scan driver is configured of only P-type transistors, e.g., PMOS transistors, the driving signals, e.g., clock signals, are not only used to turn on and turn off the PMOS transistors, but are also used to supply power. For example, a low level voltage of the driving signals may be output at a low level voltage of a scan signal. In such cases, e.g., a problem arises in that malfunction of the scan driver may increase as a result of a voltage drop and/or delay of the driving signals.

Also, in an organic light emitting display device further including an emission control driver generating an emission control signal, besides the scan driver, the emission control driver may malfunction due to the delay and the voltage drop of the driving signals and the driving powers, in the same manner of the scan driver.

### SUMMARY

Embodiments are therefore directed to an organic light emitting display device, which substantially and/or completely overcomes one or more of the problems due to limitations and disadvantages of the related art.

It is therefore a feature of an embodiment to provide an organic light emitting display device that may be capable of preventing and/or reducing malfunction of a scan driver and/or an emission control driver by minimizing and/or reducing delay and voltage drop of driving signals and driving powers supplied to the scan driver and/or the emission control driver.

It is therefore a separate feature of an embodiment to provide an organic light emitting display device including a scan driver and/or an emission control driver, wherein the scan driver and/or the emission control driver are supplied with driving signals and driving powers in at least two directions from the plurality of input terminals. Embodiments may thereby, e.g., minimize and/or reduce delay and/or voltage drop of the driving signals and driving powers supplied to the scan driver and/or the emission control driver.

At least one of the above and other features and advantages of one or more aspects of the invention may be realized by providing an organic light emitting display device, including a pixel unit including scan lines, data lines and a plurality of pixels positioned at intersecting portions of the scan lines and the data lines and electrically coupled therebetween, a driver adapted to supply driving signals to the pixel unit, and a plurality of pads, wherein the plurality of pads are adapted to supply driving powers and/or driving signals to the pixel unit and the driver, and the plurality of pads include a first subset of pads adapted to supply the same driving power and/or the same driving signal to the driver.

The display may include a plurality of input terminals, each of the input terminals may include at least one pad of the first subset of pads supplying the same power and/or the same driving signal to the driver, and the driver may be coupled to at least two of the plurality of input terminals.

The driver includes a plurality of stages cascadingly coupled to an input pad of a start pulse and is adapted to sequentially generate the driving signals, at least one of the plurality of input terminals is coupled to a first stage and at least another of the plurality input terminals is coupled to a last stage among the plurality of stages of the driver.

Other input terminals of the plurality of input terminals may be coupled between intermediate stages arranged between the first stage and the last stage.

The input terminals of the plurality of input terminals coupled between intermediate stages may be coupled directly between two of the stages and are arranged to be substantially evenly dispersed among the stages.

The at least one input terminal coupled to the first stage is coupled directly to the first stage relative to the others of the plurality of stages and the at least one input terminal coupled to the last stage may be coupled directly to the last stage relative to the others of the plurality of stages.

The pixel unit and the driver may be on one panel.

The plurality of input terminals of the driver may be dispersed among at least two different edges of the panel so that the driving powers and the driving signals are supplied to the driver from at least two different directions.

The driving powers and the driving signals supplied to the driver from the plurality of input terminals may include first and second powers of the driver and clock signals.

The driver may include P-type transistors and capacitors.

The pixel unit may further include emission control lines coupled to the pixels and the driver is an emission control driver adapted to supply emission control signals to the emission control lines.

The driver may be a scan driver adapted to supply scan signals to the scan lines.

The device may include a plurality of input terminals including a first subset and a second subset of input terminals, and the plurality of pads may include a second subset of pads, wherein the driver includes a scan driver adapted to supply scan signals to the scan lines and an emission control driver adapted to supply emission control signals to emission control lines of the pixel unit, the first subset of pads are adapted to supply the same power and/or the same driving signal to the scan driver, the scan driver is coupled to the first subset of input terminals, each of the first subset of input terminals including at least one pad of the first subset of pads, and the second subset of pads may be adapted to supply a same driving power and/or a same driving signal to the emission control driver, the emission control driver is coupled to the second subset of input terminals, each of the second subset of input terminals may include at least one pad of the second subset of pads.

Each of the scan driver and the emission control driver may include a plurality of stages cascadingly coupled, the plurality of stages of the scan driver may be coupled to an input pad of a scan start pulse and adapted to sequentially generate and supply the driving signals to the scan lines, and the plurality of stages of the emission control driver being coupled to an input pad of an emission start pulse and adapted to sequentially generate and supply the emission control signals to the emission control lines.

One input terminal of the first subset of input terminals may be coupled to a first stage of the scan driver and at least another of the input terminal of the first subset of input terminals may be coupled to a last stage among the plurality of stages of the scan driver, and one input terminal of the second subset of input terminals may be coupled to a first stage of the emission control driver and at least another input terminal of the second subset of input terminals is coupled to a last stage among the plurality of stages of the emission control driver.

Other input terminals of each of the first subset and the second subset of input terminals may be coupled between intermediate stages arranged between the first stage and the last stage of the scan driver and the emission control driver, respectively.

The driving powers and the driving signals supplied to the scan driver from the first subset of input terminals include first and second driving powers and scan clock signals, and the driving powers and the driving signals supplied to the emission control driver from the second subset of input terminals include first and second driving powers and emission clock signals.

The pixel unit, the scan driver and the emission control driver may be on one panel.

Each of the first subset and the second subset of input terminals may be dispersed among at least two different edges of the panel so that the respective driving powers and the respective driving signals may be respectively supplied to the scan driver and the emission control driver from at least two different directions.

At least one of the above and other features and advantages of one or more aspects of the invention may be realized by providing an organic light emitting display device, including a pixel unit including a plurality of data and control signal lines, the pixel unit including a plurality of pixels at intersecting portions of the respective data and control signal lines, a first control signal driver adapted to supply first control signals to respective ones of the control signal lines, and a plurality of input terminals adapted to supply a first driving power and a first driving signal to the first control signal driver and the pixel unit, wherein each of the input terminals include a pad adapted to supply the first driving power to the first control signal driver, and a pad adapted to supply the first driving signals to the first control signal driver, wherein the input terminals are each coupled to a different portion of the first control signal driver.

Embodiments may prevent and/or reduce malfunction of the scan driver and/or the emission control driver.

### BRIEF DESCRIPTION OF THE DRAWINGS

The above and other features and advantages of embodiments will become more apparent to those of ordinary skill in the art by describing in detail exemplary embodiments thereof with reference to the attached drawings, in which:

FIG. 1 illustrates a plan view of an exemplary embodiment of an organic light emitting display device;

FIG. 2 illustrates a block diagram of an exemplary embodiment of the scan driver of FIG. 1;

FIG. 3 illustrates a circuit diagram of an exemplary embodiment of a stage of the scan driver of FIG. 2;

FIG. 4 illustrates a waveform diagram of exemplary input/output signals employable by the stage of FIG. 3;

FIG. 5 illustrates a block diagram of an exemplary embodiment of the emission control driver of FIG. 1;

FIG. 6 illustrates a circuit diagram of an exemplary embodiment of a stage of the emission control driver of FIG. 5; and

FIG. 7 illustrates a waveform diagram of exemplary input/output signals employable by the stage of FIG. 6.

### DETAILED DESCRIPTION OF EMBODIMENTS

Korean Patent Application No. 10-2008-0036104, filed on Apr. 18, 2008, in the Korean Intellectual Property Office, and entitled: “Organic Light Emitting Display Device,” is incorporated by reference herein in its entirety.

Exemplary embodiments will now be described more fully hereinafter with reference to the accompanying drawings, in which exemplary embodiments are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art. Further, some of the elements that are not essential to the complete understanding of embodiments of the invention are omitted for clarity. Also, like reference numerals refer to like elements throughout the specification.

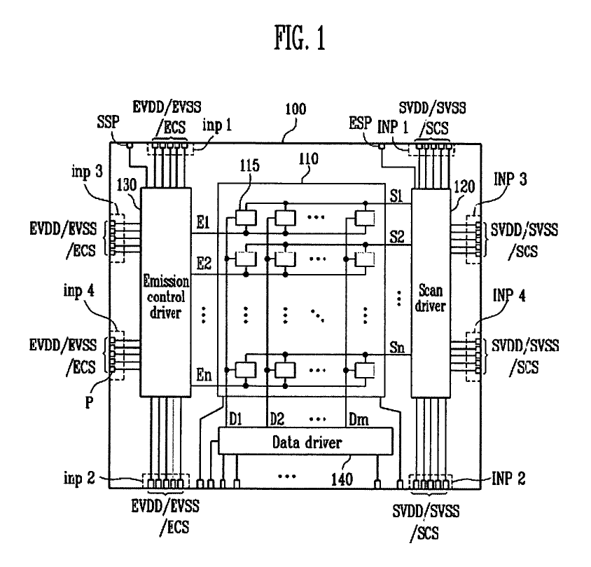

FIG. 1 illustrates a plan view of an exemplary embodiment of an organic light emitting display device.

Referring to FIG. 1, the organic light emitting display device may include a panel 100. The panel 100 may include a pixel unit 110, a scan driver 120, an emission control driver 130, a data driver 140 and a plurality of pads P.

The pixel unit 110 may include scan lines S1 to Sn, emission control lines E1 to En, data lines D1 to Dn, and a plurality of pixels 115 positioned at intersections thereof.

The pixels 115 may be electrically coupled to respective ones of the scan lines S1 to Sn, the emission control lines E1 to En, and the data lines D1 to Dm. The pixels 115 may emit light corresponding to the scan signals, emission control signals and data signals that may be supplied thereto by the scan lines S1 to Sn, the emission control lines E1 to En, and the data lines D1 to Dm, respectively.

The pixel unit 110 may receive a first driving power SVDD, EVDD and a second driving power SVSS, EVSS from the pads P and may transfer the first driving power SVDD and the second driving power SVSS to the respective pixels 115. The first driving power SVDD supplied to the scan driver 120 may be the same as the first driving power EVDD supplied to the emission control driver 130. The second driving power SVDD supplied to the scan driver 120 may be the same as the second driving power EVDD supplied to the emission control driver 130.

The scan driver 120 may generate scan signals corresponding to the first driving power SVDD, the second driving power SVSS and scan driving signals SCS that may be supplied to the scan driver 120 from the pads P. The scan driving signals SCS may include clock signals of the scan driver 120. The scan driver 120 may supply the generated scan signals to the pixels 115 via the scan lines S1 to Sn.

The emission control driver 130 may generate emission control signals corresponding to the first driving power EVDD, the second driving power EVSS and emission driving signals ECS that may be supplied to the emission control driver 130 from the pads P. The emission driving signals ECS may include clock signals of the emission control driver 130. The emission control driver 130 may supply the generated emission control signals to the pixels 115 via the emission control lines E1 to En.

The data driver 140 may generate data signals corresponding to data and data driving control signals supplied from the pads P. The data driver 140 may supply the generated data signals to the pixels 115 via the data lines D1 to Dm.

The pads P may be formed on edges of the panel 100. The pads P may supply the driving powers, e.g., SVDD, EVDD, SVSS, EVDD, and the driving signals, e.g., SCS, ECS, to the pixel unit 110, the scan driver 120, the emission control driver 130 and/or the data driver 140.

More particularly, in embodiments, a plurality of the pads P may supply the same driving power, e.g., SVDD, EVDD, SVSS or EVSS, or the same driving signal, e.g., SCS or ECS, to the scan driver 120 and the emission control driver 130, respectively. For example, two or more of the pads P may supply the first driving power SVDD to the scan driver 120 and/or two or more other ones of the pads P may supply the first driving power EVDD to the emission control driver 130. Respective ones of the pads supplying the same driving power, e.g., SVDD, EVDD, SVSS or EVSS, or the same driving signal, e.g., SCS or ECS, may be dispersively arranged on the panel 100.

In the exemplary embodiment illustrated in FIG. 1, the panel 100 includes a plurality of input terminals INP associated with the scan driver 120, and a plurality of input terminals inp associated with the emission control driver 130 and the input terminals INP, inp are dispersed on the panel 100. Each of the input terminals INP corresponding to the scan driver 120 may be associated with a respective one of the plurality of pads P for supplying the first driving power SVDD, a respective one of the plurality of pads P for supplying the second driving power SVSS and/or a respective one of the pads P for supplying the scan driving signals SCS. Each of the input terminals inp corresponding to the emission control driver 130 may be associated with a respective one of the plurality of pads P for supplying the first driving power EVDD, a respective one of the plurality of pads P for supplying the second driving power EVSS and a respective one of the pads P for supplying the emission driving signals ECS.

More particularly, the exemplary embodiment of FIG. 1 includes four of the input terminals INP corresponding to the scan driver 120 and four the input terminals inp corresponding to the emission control driver 130 such that four of the pads P may supply the first driving power SVDD to the scan driver 120, another four of the pads P may supply the first driving power EVDD to the emission control driver 130, another four of the pads P may supply the second driving power SVSS to the scan driver 120, another four of the pads P may supply the second driving power EVSS to the emission control driver 130, another four of the pads P may supply the scan driving signal SCS to the scan driver 120, and another four of the pads P may supply the emission driving signals ECS to the emission control driver 130.

Although FIG. 1 illustrates a plurality, e.g., four, of input terminals INP1 to INP4 associated with the scan driver 120 and a plurality, e.g., four, of input terminals inp1 to inp4 associated with the emission control driver 130, embodiments are not limited thereto. For example, in some embodiments, only the scan driver 120 or the emission control driver 130 may have a plurality, e.g., two or more, of input terminals, e.g., INP, inp, associated therewith and the other of the scan driver 120 or the emission control driver may have a fewer number of input terminals or a single pad for each of the powers/signals associated therewith. Further, embodiments may include any number of input terminals, e.g., INP, inp, associated with each of the scan driver 120 and the emission driver 140, i.e., not limited to four.

Further, in embodiments, the plurality of input terminals, e.g., INP1 to INP4, inp1 to inp4, may be dispersively arranged about the corresponding driver, e.g., the scan driver 120, the emission control driver 130. More particularly, e.g., in embodiments, corresponding ones of the input terminals, e.g., INP, inp, may be evenly or substantially evenly dispersed along one or more sides or portions of the respective driver, e.g., the scan driver 120, the emission control driver 130, closer to and/or facing the pads P. More particularly, e.g., referring to the exemplary embodiment of FIG. 1, in embodiments including a plurality of input terminals, e.g., inp1, inp2, inp3, inp4, associated with the emission control driver 130, the corresponding input terminals inp1, inp2, inp3, inp4 may be arranged, e.g., along one or more sides of the emission control driver 130 not facing the pixel unit 110 and/or along one or more sides of the emission control driver 130 from which the emission control lines E1 to En do not extend out from. In embodiments including a plurality of input terminals, e.g., INP1, INP2, INP3, INP4, associated with the scan driver 120, the corresponding input terminals INP1, INP2, INP3, INP4 may be arranged, e.g., along one or more sides of the scan driver 140 not facing the pixel unit 110 and/or along one or more sides of the scan driver 140 from which the scan lines S1 to Sn do not extend out from.

In the exemplary embodiment of FIG. 1, two of the input terminals INP1 and INP2, inp1 and inp2 associated with each of the scan driver 120 and the emission control driver 130 are provided on opposing sides, e.g., upper and lower sides, of the scan driver 120 and the emission control driver 130, respectively. By arranging the input terminals, e.g., INP1 and INP2, inp1 and inp2, on opposing sides of the scan driver 120 and/or the emission control driver 130, driving powers and/or driving signals may be supplied from at least two different directions. More particularly, in the embodiment of FIG. 1, the input terminals, e.g., INP1 and INP2, inp1 and inp2, are arranged on two of the sides, of the respective driver 120, 140, which are furthest from one another.

Others of the plurality of input terminals, e.g., third and fourth input terminals INP3 and INP4, inp3 and inp4 associated with each of the scan driver 120 and the emission control driver 130, respectively, may be arranged along other portions of the sides where the first and second input terminals INP1 and INP2, inp1 and inp2 are arranged or on other sides of the respective scan driver 120 and the emission control driver 130 where the first and second input terminals INP1 and INP2, inp1 and inp2 are not formed. In the exemplary embodiment of FIG. 1, a plurality of the other the third and fourth input terminals INP3 and INP4, inp3 and inp4 associated with each of the scan driver 120 and the emission control driver 130, respectively, are arranged on a same side of driver 120, 140 facing away from the pixel unit 110 and along which the respective first and second input terminals INP1 and INP2, inp1 and inp2 are not arranged.

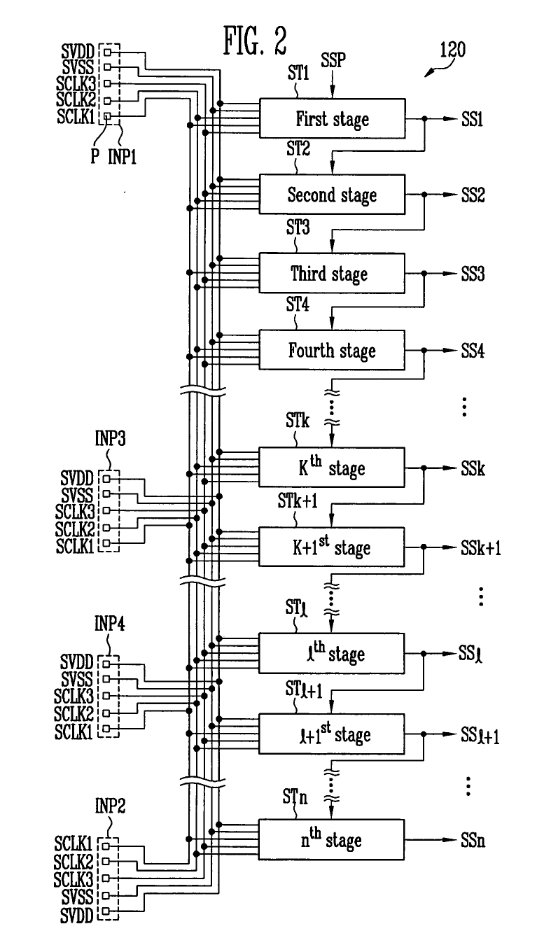

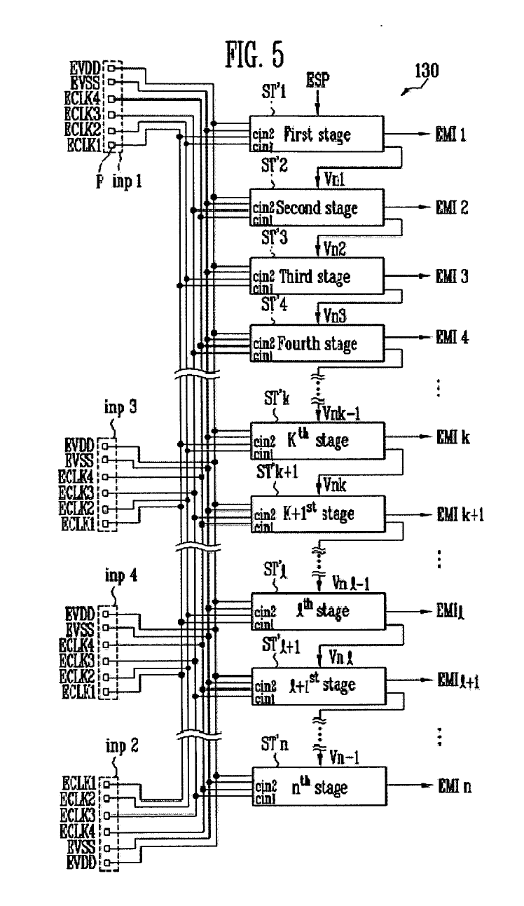

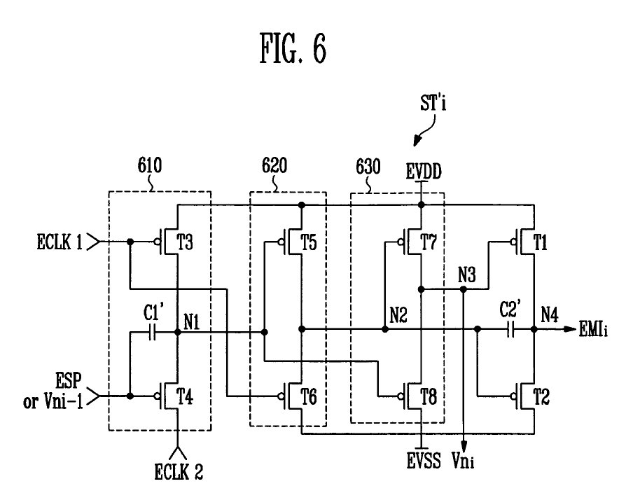

The panel 100 may include pads supplying, e.g., a scan start pulse SSP of the scan driver 120 to the scan driver 120 and pads supplying an emission start pulse ESP of the emission control driver 130 to the emission control driver 130. Such pads may each be arranged individually, making it possible to supply start pulses of the scan driver 120 and the emission control driver 130 to, e.g., a first stage ST1, ST′1 (see FIGS. 2 and 5) of the scan driver 120 and the emission control driver 130.

As described above, embodiments may provide a scan driver and/or an emission control driver that may be supplied with driving powers and driving signals in at least two directions from a plurality of input terminals arranged on at least two edges of the panel 100, where the two edges may be different from each other. Embodiments may minimize and/or reduce delay and/or voltage drop of the driving signals and driving powers supplied to the scan driver 120 and/or the emission control driver 130.

More particularly, embodiments may supply driving signals and/or driving powers to a first stage ST1, ST′1 and/or a last stage STn, ST′n (see, FIGS. 2 and 5) of the scan driver 120 and/or the emission control driver 130 and/or to intermediate stages ST2 to STn−1 or ST′2 to ST′n−1 thereof. Thereby, embodiments may effectively prevent and/or reduce delay and voltage drop of the driving signals and the driving powers supplied to the scan driver 120 and/or the emission control driver 130.

Accordingly, embodiments may prevent and/or reduce malfunction of the scan driver 120 and/or the emission control driver 130.

Meanwhile, FIG. 1 illustrates the panel 100 of the organic light emitting display device including the pixel unit 110, the scan driver 120, the emission control driver 130, the data driver 140 and the plurality of pads P supplying the driving signals and the driving powers thereto. Embodiments are not limited thereto. For example, in embodiments, the panel 100 may not include the emission control driver 130 and/or a scan signal generator and an emission control signal generator may be formed on the panel 100. More particularly, in embodiments, e.g., the scan signal generated may be included within the scan driver. Further, e.g., in embodiments, the data driver 140 may be mounted outside, e.g., FPCB, the panel 100 to supply the data signals to the pixel unit 110 through the pads P.

Also, for convenience, in FIG. 1 the input terminals INP1 to INP4, inp1 to inp4 of the scan driver 120 and the emission control driver 130 each include five pads P to supply SVDD, SVSS and SCS or EVDD, EVSS and ECS. However, the number of thereof may be changed according to circuit constitutions of the scan driver 120 and the emission control driver 130.

FIG. 2 illustrates a block diagram of an exemplary embodiment of the scan driver of FIG. 1.

Referring to FIG. 2, the scan driver 120 may include a plurality of stages, e.g., ST1 to STn, cascadingly coupled to an input terminal of a scan start pulse SSP.

The respective stages ST1 to STn may be coupled to receive driving powers, e.g., SVDD, SVSS, and driving signals, e.g., SCS, of the scan driver 120. For example, the respective stages ST1 to STn may be coupled to supply lines of the first driving power SVDD, the second driving power SVSS and the scan driving signals SCS. First, second and third clock signals SCLK1, SCLK2 and SCLK3, which may be delayed in phase and may be sequentially supplied, may be included in the SCS.

The stages ST1 to Stn may sequentially generate scan signals SS1 to SSn, corresponding to the scan start pulse SSP, and may respectively output them.

More specifically, the first stage ST1 may receive the scan start pulse SSP and the clock signals SCLK1, SCLK2, SCLK3. The first stage ST1 may phase delay the start pulse based on the clock signals SCLK1 to SCLK3 and may output a first stage output signal SS1. The first stage output signal SS1 may be phase delayed by one clock cycle.

The second to the nth stages ST2 to STn may respectively receive an output signal SS output by, e.g., a previous stage ST1 to STn−1, and the clock signals SCLK1, SCLK2, SCLK3 and may supply an output signal SS2 to SSn, respectively. For example, the second stage ST2 may receive the first stage signal output SS1 from the first stage ST1. The second to the nth stages ST2 to STn may phase delay, e.g., by one clock cycle, the output signal from the corresponding previous stage and may output the respective output signal SS2 to SSN.

In such embodiments, the output signals SS1 to SSN may be sequentially phase delayed. The generated output signals SS1 to SSn may be sequentially supplied to the respective scan lines S1 to Sn.

Meanwhile, although FIG. 2 shows the stages ST1 to STn driven by three sequentially phase delayed clock signals SCLK1 to SCLK3, embodiments are not limited thereto.

For example, the stages ST1 to STn may be driven by four sequentially phase delayed clock signals. In such cases, e.g., the respective stages ST may receive only three clock signals of the four clock signals to generate the output signals SS corresponding thereto. More particularly, e.g., in such cases, the first stage ST1 may receive first, third, and fourth clock signals, and the second stage ST2 may receive second, fourth, and first clock signals. The first, second, third and fourth clock signals may be sequentially phase delayed by one clock. The third to nth stages ST3 to STn may receive three sequentially phase delayed clock signals by in the same manner.

Referring to FIG. 2, in embodiments, some input terminals of the plurality of input terminals INP1 to INP4 of the scan driver 120 of FIG. 1 may first be electrically coupled to the first stage ST1 and/or the n^{th} stage STn. For example, the first and second input terminals INP1, INP2 may first be electrically coupled to the first stage ST1 and the n^{th} stage STn, respectively. More particularly, referring to FIG. 2, e.g., relative to the stages, e.g., ST1 to STn, the first input terminal INP1 may be electrically coupled to the first stage ST1 before being electrically coupled to the second stage ST2 and/or the first input terminal INP1 may be directly coupled to the first stage ST1 and indirectly, via the first stage ST1, coupled to the second stage ST2. That is, e.g., a signal line extending from the respective pads P of the first input terminal INP1 may, relative to the stages ST1 to STn, be first electrically coupled to the first stage ST1.

The other input terminals, e.g., the third and fourth input terminals INP3, INP4 may first be electrically coupled intermediate stages ST positioned between the first stage ST1 and the n^{th} stage STn. For example, relative to the stages ST1 to STn, the third input terminal INP3 may be first electrically coupled between a k^{th} stage STk and a k+1^{st} stage STK+1, and the fourth input terminal INP4 may be first electrically coupled between a l^{th} stage STl and a l+1^{st} stage STl+1. More particularly, e.g., the third input terminal INP3 may be directly coupled between a k^{th} stage STk and a k+1^{st} stage STK+1, and the fourth input terminal INP4 may be directly coupled between a l^{th} stage STl and a l+1^{st} stage STl+1.

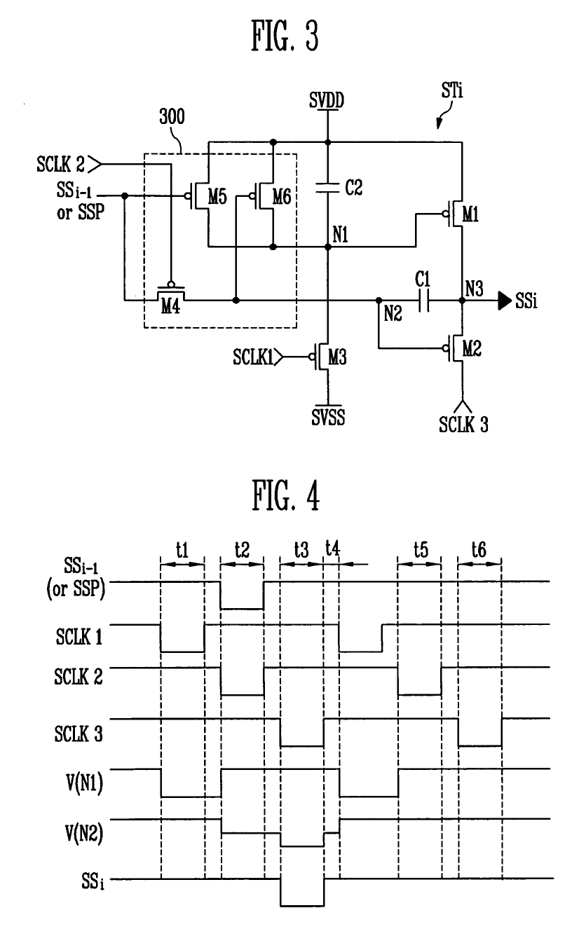

FIG. 3 illustrates a circuit diagram of an exemplary embodiment of a stage STi of the scan driver of FIG. 2. For convenience, FIG. 3 illustrates one example of the stage STi configured of one type of transistor, e.g., P-type transistors PMOS, and capacitors. However, embodiments are not limited thereto.

Referring to FIG. 3, a stage STi may include a voltage level controller 300, first, second and third transistors M1, M2, M3 and first and second capacitors C1 and C2.

The voltage level controller 300 may control voltage levels of a first node N1 and a second node N2 to be a high level or a low level, corresponding to the scan start pulse SSP or the output signals SSi-1 and SCLK2 of a previous stage.

The voltage level controller 300 may include fourth, fifth and sixth transistors M4, M5, M6.

The fourth transistor M4 may be coupled between an input line of the scan start pulse SSP or the output signal SSi-1 of a previous stage and the second node N2. A gate electrode of the fourth transistor M4 may be coupled to an input line of the second clock SCLK2. In such cases, the fourth transistor M4 may be turned on when the second clock signal SCLK2 having a low level is supplied to the gate electrode of the fourth transistor M4. When the fourth transistor M4 is turned on, the scan start pulse SSP or the output signal SSi-1 of the previous stage STi−1 may be supplied to the second node N2 of the stage STi.

The fifth transistor M5 may be coupled between a source of the first driving power SVDD, e.g., a high-level voltage source, and the first node N1. A gate electrode of the fifth transistor M5 may be coupled to the input line of the scan start pulse SSP or output signals SSi-1 of a previous stage, e.g., STi−1. The fifth transistor M5 may be turned on when a low-level scan start pulse SSP or output signal SSi-1 of a previous stage STi−1 is supplied to its gate electrode. When the fifth transistor M5 is turned on, the first node N1 of the stage STi may be electrically coupled to the first driving power SVDD source.

The sixth transistor M6 may be coupled between the first driving power SVDD source and the first node N1. A gate electrode of the sixth transistor M6 may be coupled to the second node N2. The sixth transistor M6 may be turned on when a voltage level of the second node N2 drops to a low value that is below a predetermined value. When the sixth transistor M6 is turned on, the first node N1 of the stage STi may be electrically coupled to the first driving power SVDD source.

As such, the voltage level controller 300 may control a voltage level of the second node N2 based on the scan start pulse SSP or the output signal SSi-1 of the previous stage, e.g., STi−1 and the second clock signal SCLK2, and may control a voltage level of the first node N1 based on the scan start pulse SSP or the output signal SSi-1 of the previous stage, e.g., STi−1 and the voltage level of the second node N2 of the previous stage, e.g., STi−1.

Referring still to FIG. 3, the first transistor M1 of the stage STi may be coupled between the first driving power SVDD source and a third node N3. The third node N3 may correspond to an output node coupled to an output line of the stage STi. A gate electrode of the first transistor M1 may be coupled to the first node N1. The first transistor M1 may be turned on when a voltage level of the first node N1 is low. More particularly, e.g., the first transistor M1 may be turned on when a voltage value of the first node N1 is less than a voltage value of a source electrode of the first transistor M1. When the first transistor M1 is turned on, the first driving power SVDD source may be electrically coupled to the output line of the stage STi, i.e., the third node N3.

The second transistor M2 may be coupled between the third node N3 and an input line of the third clock signal SCLK3. A gate electrode of the second transistor M2 may be coupled to the second node N2. The second transistor M2 may be turned on when a voltage level of the second node N2 is low. When the second transistor M2 is turned on, the output line of the stage STi may be coupled to the input line of the third clock signal SCLK3. Thus, when the second transistor M2 is turned on, a voltage level of the output signal SSi may become the same as that of the third clock signal SCLK3.

The third transistor M3 may be coupled between the first node N1 and a source of the second driving power SVSS, e.g., a low-level voltage source that has a voltage level lower than the first driving power SVDD source. A gate electrode of the third transistor M3 may be coupled to an input line of the first clock signal SCLK1. The third transistor M3 may be turned on when the first clock signal SCLK1 is at a low level. When the third transistor M3 is turned on, the first node N1 may be electrically coupled to the second driving power SVSS source.

The first capacitor C1 may be coupled between the second node N2 and the third node N3. The first capacitor C1 may charge a predetermined voltage value corresponding to a potential difference between both terminals thereof. The first capacitor C1 may stabilize an operation of the second transistor M2.

The second capacitor C2 may be coupled between the first driving power SVDD source and the first node N1. The second capacitor C2 may reduce fluctuation of voltages applied to the first driving power SVDD source and/or the first node N1.

In the exemplary embodiment of the stage STi illustrated in FIG. 3, all of the transistors, e.g., M1 to M6 included in the stage STi are of a same type, e.g., P-type transistors. By designing the stage STi to include transistors of one type, it is possible to simplify a manufacturing process thereof. However, embodiments are not limited thereto.

Further, as discussed above, in embodiments, when the scan driver 120 is supplied with driving signals and driving powers from a plurality of input terminals INP as shown in FIGS. 1 and 2, delay and/or voltage drop of the driving signals and the driving powers may be prevented and/or reduced. Therefore, the exemplary stage STi of FIG. 3 may be stably operated.

Meanwhile, although the clock signals SCLK1, SCLK2 and SCLK3 may be supplied, respectively, to any one electrode of the third, fourth and second transistors M3, M4, M2 of the stage STi of FIG. 3, the clock signals SCLK1, SCLK2 and SCLK3 supplied to the respective stages ST may be supplied by being shifted by one clock per stage ST.

For example, in a stage, e.g., STi+1, following the stage STi of FIG. 3, SCLK2, SCLK3 and SCLK1 shifted by one clock may be supplied, respectively, to any one electrode of the third, fourth and second transistors M3, M4, M2 of the following stage STi+1.

Hereinafter, an exemplary operation of the exemplary stage STi of FIG. 3 will be described in detail in association with waveforms of exemplary input/output signals of FIG. 4. FIG. 4 illustrates a waveform diagram of exemplary input/output signals employable by the stage of FIG. 3. For convenience, elements such as threshold voltage of transistors will not be considered.

Referring to FIG. 4, during a first period t1, an output signal SSi-1 (or, scan start pulse SSP) of a previous stage ST−1 may be at a high level. Referring to FIG. 3, output signal SSi-1 (or, the scan start pulse SSP) may be supplied to a source electrode of the fourth transistor M4 and the gate electrode of the fifth transistor M5.

Also, during the first period t1, the first clock signal may be at a low-level SCLK1 and may be supplied to the gate electrode of the third transistor M3. The second and third clock signals SCLK2 and SCLK3 may be at a high level and may be supplied to the gate electrode of the fourth transistor M4 and a drain electrode of the second transistor M2, respectively. Herein, the SCLK1, SCLK2 and SCLK3 may be signals having sequentially phase-delayed signals.

Thereby, during the first period t1, the fourth and fifth transistors M4, M5 may maintain an off state and the third transistor M may be turned on.

When the third transistor M3 is turned on, a voltage of the second driving power SVSS source may be transferred to the first node N1. Therefore, during the first period t1, the first node N1 may be charged with a low-level voltage.

As a voltage of the first node N1 may drop to a low level, the first transistor M1 may be turned on to supply a voltage of the first driving power SVDD source to the output line of the stage STi. Therefore, the output signal SSi output from the stage STi may maintain a high level during the first period t1. Further, a voltage at the second node N2 may maintain a high value without any special fluctuation.

During a second period t2, the output signal SSi-1 (or, the scan start pulse SSP) of the previous stage, e.g., STi−1, having a low level, may be supplied to the source electrode of the fourth transistor M4 and the gate electrode of the fifth transistor M5.

Also, during the second period t2, the first clock signal SCLK1 at a high level may be supplied to the gate electrode of the third transistor M3, the second clock SCLK2 at a low level may be supplied to the gate electrode of the fourth transistor M4 and the third clock signal SCLK3 at a high level may be supplied to the drain electrode of the second transistor M2.

Thereby, during the second period t2, the fourth transistor M4 may be turned on corresponding to the low-level of the second clock signal SCLK2. Thus, a low value of the output signal SSi-1 (or, the scan start pulse SSP) of the previous stage, e.g., STi−1, may be transferred to the second node N2 and the second node N2 may be charged with the low value.

Also, during the second period t2, the fifth transistor M5 may be turned on by the low level of the output signal SSi-1 (or, the scan start pulse SSP) of the previous stage STi−1. During the second period t2, the sixth transistor M6 may also be turned on as the second node N2, corresponding to the gate electrode of the sixth transistor M6, may be charged with the low value. When the sixth transistor M6 is turned on, the first node N1 may be charged with the high-level voltage of the first driving power SVDD source.

Further, during the second period t2, as the first node N1 is charged with the high-level voltage of the first driving power SVDD source, the first transistor M1 may be turned off. Referring still to FIGS. 3 and 4, as the second node N2 is charged with the low value, the second transistor M2 may be turned on so that the high-level of the third clock signal SCLK3 may be supplied to the output line SSi of the stage STi. At this time, the first capacitor C1 may be charged with a voltage capable of turning on the second transistor M2.

During a third period t3, the output signal SSi-1 (or, the scan start pulse SSP) of the previous stage having a high level may be supplied to the source electrode of the fourth transistor M4 and the gate electrode of the fifth transistor M5.

Also, during the third period t3, the first clock signal SCLK1 and the second clock signal SCLK2 may have a high level and may be supplied to the gate electrode of the third transistor M3 and the gate electrode of the fourth transistor M4, respectively. The third clock signal SCLK3 may have a low level and may be supplied to the drain electrode of the second transistor M2.

In such cases, during the third period t3, the third, fourth and fifth transistors M3, M4, M5 may be turned off based on the high level of the output signal SSi-1 (or, the scan start pulse SSP) of the previous stage and the high levels of the first and second clock signals SCLK1 and SCLK2.

As discussed above, during the second period t2, a voltage capable of turning on the second transistor M2 may be stored in the first capacitor C1. Using the voltage stored in the first capacitor C1 during the second period t2, during the third period t3, the second transistor M2 may maintain an on state. Thereby, during the third period t3, a waveform of the output signal SSi of the stage STi may follow a waveform of the third clock signal SCLK3. Referring to FIG. 4, during the third period t3, the output signal SSi of the stage STi may have a low level.

Referring to FIG. 4, during the third period t3, as the third clock signal SCLK3 is changed from the high level to the low level, the second node N2 may be charged with a lower value than the low value charged at the second node N2 during the t2 period. More particularly, the second node N2 may be charged with the lower value during the third period t3 as a result of a coupling reaction of a capacitor (not shown) between the gate and the source of the second transistor M2.

As the second node N2 may be charged with the lower value, the sixth transistor M6 may remain on and the first node N1 may be charged with the high level voltage of the first driving power SVDD source.

During a fourth period t4, the output signal SSi-1 (or, the scan start pulse SSP) of the previous stage, having a low level, may be supplied to the source electrode of the fourth transistor M4 and the gate electrode of the fifth transistor M5.

Also, during the fourth period t4, the first, second and third clock signals SCLK1, SCLK2 and SCLK3 may have a high level and may be supplied to the gate electrode of the third transistor M3, the gate electrode of the fourth transistor M4, and the drain electrode of the second transistor M2, respectively.

Then, the third and fourth transistors M3, M4 may maintain an off state corresponding to the high levels of the first and second clock signals, respectively. The fifth transistor M5 may be turned on as a result of the low level output signal SSi-1 (or, the scan start pulse SSP) of the previous stage. As the fifth transistor M5 is turned on, the first node N1 may be charged with the high-level voltage of the first driving power SVDD source. Thus, the first node N1 may be maintained at the high level such that the first transistor M1 may be maintained in an off state.

During the fourth period t4, the second transistor M2 may maintain an on state based on a voltage charged in the first capacitor C1. Thus, during the fourth period, the output signal SSi of the stage STi may have a high value, corresponding to the waveform of the third clock signal SCLK3.

Referring still to FIG. 4, during the fourth period t4, the second node N2 may be charged with an intermediate-level value increased by a predetermined value from the lower value during the t3 period. More particularly, the second node N2 may be charged with the intermediate-level value based on the coupling reaction of the capacitor between the gate and the source of the second transistor M2 and the intermediate-level value may be similar or identical to the value of the second node N2 during the second period t2. In embodiments, the intermediate-level value may be less than or equal to a maximum voltage for turning on the sixth transistor M6 such that the sixth transistor M6 may be in an on state during the fourth period t4. As a result of the sixth transistor M6 being on, the first node N1 may maintain a high value. Further, during the fourth period t4, as the second transistor M2 may be in an on state as a result of the coupling reaction, the output of the stage STi may have a high level, corresponding to the high level of the third clock signal SCLK3.

During subsequent periods, e.g., t5, t6, the output signals SSi-1 (or, the scan start pulse SSP) of the previous stage may maintain a high-level so that the output signals SSi of the stage STi may maintain a high-level.

For example, although the second clock signal SCLK2 may have a low level during the 5th period, the output signal SSi-1 (or, the scan start pulse SSP) of the previous stage may continuously maintain a high-level via the fourth transistor M4, such that the second node N2 may be charged with the high value. Thereby, a voltage capable of turning off the second transistor T2 may be stored in the second node N2. Thus, even if the third clock signal SCLK3 is at a low level, e.g., during the sixth period t6, the second transistor T2 may be maintained in an off state as a result of the voltage at the second node N2 and the output signal SSi of the stage STi may maintain a high level. Thereby, the output signals SSi of the stage STi may maintain a high-level regardless of the value of the third clock signal SCLK3.

Using the exemplary driving waveforms described above, the stages ST of the scan driver 120 may enable the output signals SSi-1 (or, the scan start pulse SSP) of the previous stage input to itself to be phase-delayed by one clock corresponding to the first, second and third clock signals SCLK1 to SCLK3 and the resulting phase-delayed signals may be the output line of the respective stage.

FIG. 5 illustrates a block diagram of an exemplary embodiment of the emission control driver 130 of FIG. 1.

Referring to FIG. 5, the emission control driver 130 may include a plurality of stages ST1 to STn cascadingly coupled to input terminals of an emission start pulse ESP. In the exemplary embodiment of FIG. 5, the stages ST′1 to ST′n each are coupled to supply lines of two emission clock signals ECLK of supply lines of first to fourth emission clock signals ECLK1, ECLK2, ECLK3, ECLK4.

The first emission clock signal ECLK1 and the second emission clock signal ECLK2 may have waveforms opposite to each other. In other words, the second emission clock signal ECLK2 may be a clock signal ECLK1B (see FIG. 7) having a waveform opposite to the first emission clock signal ECLK1. Also, the third emission clock signal ECLK3 and the fourth emission clock signal ECLK4 may have waveforms opposite to each other. In other words, the fourth emission clock signal ECLK4 may be a clock signal ECLK3B (see FIG. 7) having a waveform opposite to the third emission clock signal ECLK3.

Periods of the first emission clock signal ECLK1 and the third emission clock signal ECLK3 may be the same. The emission clock signals ECLK may have a phase difference by a predetermined period. For example, the first emission clock signal ECLK1 and the third emission clock signal ECLK3 may have a phase difference corresponding to a ¼ period (or, a ¾ period).

The stages ST′1 to ST′n may each be coupled to input lines of two of the emission clock signals ECLK having opposite waveforms. More particularly, e.g., in the exemplary embodiment of FIG. 5, the stages ST′1 to ST′n may each be supplied with the first emission clock signal ECLK1 and the second emission clock signal ECLK2, or may be supplied with the third emission clock signal ECLK3 and the fourth emission clock signal ECLK4.

The stages ST′1 to ST′n may each have two output terminals. More particularly, each of the stages ST′1 to ST′n may include a first output terminal that supplies a first output signal Vn1 to Vnn and a second output terminal that supplies an emission control signal EMI1 to EMIn.

For example, an ith stage ST′i, may output an ith first output signal Vni having a same shape as the same waveform as the emission start pulse ESP or an i-1th output signal Vni-1 of a previous stage ST′i−1, but phase-delayed by a predetermined period. The output terminal of the ith stage ST′i may be coupled to an input terminal of a next stage ST′i+1. For example, a first output terminal Vn1 of the first stage ST′1 may be coupled to an input terminal of the second stage ST′2.

The ith stage ST′1 may also output an emission control signal EMIi having a shape that is opposite to the waveform of the emission start pulse ESP or the i-1th output signal Vni-1 of the previous stage and phase-delayed by a predetermined period. The second output terminal of the ith stage ST′1 may be coupled to the ith emission control line Ei.

A first stage ST′1 may receive the emission start pulse ESP and may output a first emission control signal EMI1 and a first output signal Vn1 of the first stage ST′1. The first output signal Vn1 of the first stage ST′1 may correspond to a phase-delayed version of the emission start pulse ESP. More particularly, the first output signal Vn1 of the first stage ST′1 may correspond to the emission start pulse ESP, phase delayed by a predetermined period corresponding to the first emission clock signal ECLK1 and the second emission clock signal ECLK2. The first emission control signal EMIL may correspond to an inverse of the first output signal Vn1 (see FIG. 7).

Further, referring to FIG. 5, in embodiments, e.g., the first emission clock signal ECLK1 may be supplied to a first clock input terminal cin1 of the first stage ST′1 and the second emission clock signal ECLK2 may be supplied to a second clock input terminal cin2 of the first stage ST′1.

A second stage ST′2 may receive the first output signal Vn1 of the first stage ST′1 and may output a second emission control signal EMI2 and a first output signal Vn2 of the second stage ST′2. The first output signal Vn2 of the second stage ST′2 may correspond to a phase delayed version of the first output signal Vn1 of the first stage ST′1. More particularly, the first output signal Vn2 of the second stage ST′2 may correspond to the first output signal Vn1 of the first stage ST′1, phase delayed by a predetermined period corresponding to the third emission clock signal ECLK3 and the fourth emission clock signal ECLK4. The second emission clock signal EMI2 may correspond to an inverse of the first output signal Vn2 of the second stage ST′2.

Further, referring to FIG. 5, in embodiments, e.g., the third emission clock signal ECLK3 may be supplied to a first clock input terminal cin1 of the second stage ST′2 and the fourth emission clock signal ECLK4 may be supplied to a second clock input terminal cin2 of the second stage ST′2.

A third stage ST′3 may receive the first output signal Vn2 of the second stage ST′2 and may output a third emission control signal EMI3 and a first output signal Vn3 of the third stage ST′3. The first output signal Vn3 of the third stage ST′3 may correspond to a phase delayed version of the first output signal Vn2 of the second stage ST′2. More particularly, the first output signal Vn3 of the third stage ST′3 may correspond to the first output signal Vn2 of the second stage ST′2, phase delayed by a predetermined period corresponding to the third emission clock signal ECLK3 and the fourth emission clock signal ECLK4.

Further, referring to FIG. 5, in embodiments, e.g., the first emission clock signal ECLK1 may be supplied to a second clock input terminal cin2 of the third stage ST′3 and the second emission clock signal ECLK2 may be supplied to a first clock input terminal cin1 of the third stage ST′3. That is, relative to the first stage ST′1, in embodiments, e.g., the first and second emission clock signals ECLK1, ECLK2 may be supplied to clock input terminals cin1, cin2 of the third stage ST′3 in an opposite manner.

A fourth stage ST′4 may receive the first output signal Vn3 of the third stage ST′3 and may output a fourth emission control signal EMI4 and a first output signal Vn4 of the fourth stage ST′4. The first output signal Vn4 of the fourth stage ST′4 may correspond to a phase delayed version of the first output signal Vn3 of the third stage ST′3. More particularly, the first output signal Vn4 of the fourth stage ST′4 may correspond to the first output signal Vn3 of the third stage ST′3, phase delayed by a predetermined period corresponding to the third emission clock signal ECLK3 and the fourth emission clock signal ECLK4.

Further, referring to FIG. 5, in embodiments, e.g., the third emission clock signal ECLK3 may be supplied to a second clock input terminal cin2 of the fourth stage ST′2 and the fourth emission clock signal ECLK4 may be supplied to the first clock input terminal cin2 of the fourth stage ST′4. That is, relative to the second stage ST′2, in embodiments, e.g., the third and fourth emission clock signals ECLK3, ECLK4 may be supplied to clock input terminals cin1, cin2 of the fourth stage ST′4 in an opposite manner.

Similarly, the fifth to nth stages ST′5 to ST′n may receive the first output signal Vni-1 of the respective previous stage ST′i−1 and may output a respective emission control signal EMIi and a respective first output signal Vni. The respective first output signal Vni may correspond to a phase delayed version of the first output signal Vni-1 of the respective previous stage ST′i−1. More particularly, the first output signal Vni of the ith stage ST′I may correspond to the first output signal Vni-1 of the respective previous stage ST′i−1, phase delayed by predetermined period corresponding to the first and second emission clock signals ECLK1 and ECLK2 or the third and fourth emission clock signals ECLK3 and ECLK4.

The emission control signals EMI1 to EMIn generated from the respective stages ST′1 to ST′n may be sequentially supplied to the respective emission control lines E1 to En.

In embodiments, some input terminals of the plurality of input terminals, e.g., inp1 to inp4, of the emission control driver 130 of FIG. 1 may first be electrically coupled to the first stage ST′1 and/or the n^{th} stage ST′n. For example, the first and second input terminals inp1, inp2 may first be electrically coupled to the first stage ST′1 and the n^{th} stage ST′n, respectively. More particularly, referring to FIG. 5, e.g., relative to the stages, e.g., ST′1 to ST′n, the first input terminal inp1 may be electrically coupled to the first stage ST′1 before being electrically coupled to the second stage ST′2 and/or the first input terminal inp1 may be directly coupled to the first stage ST′1 and indirectly, via the first stage ST′1, coupled to the second stage ST′2. That is, e.g., a signal line extending from the respective pads P of the first input terminal inp1 may, relative to the stages ST′1 to ST′n, be first electrically coupled to the first stage ST′1.

The other input terminals, e.g., the third and fourth input terminals inp3, inp4 may first be electrically coupled intermediate stages ST′ positioned between the first stage ST′1 and the n^{th} stage ST′n. For example, relative to the stages ST′1 to ST′n, the third input terminal inp3 may be first electrically coupled between a k^{th} stage ST′k and a k+1^{st} stage ST′K+1, and the fourth input terminal inp4 may be first electrically coupled between a l^{th} stage ST′l and a l+1^{st} stage ST′l+1. More particularly, e.g., the third input terminal inp3 may be directly coupled between a k^{th} stage ST′k and a k+1^{st} stage ST′K+1, and the fourth input terminal INP4 may be directly coupled between a l^{th} stage ST′l and a l+1^{st} stage ST′l+1.

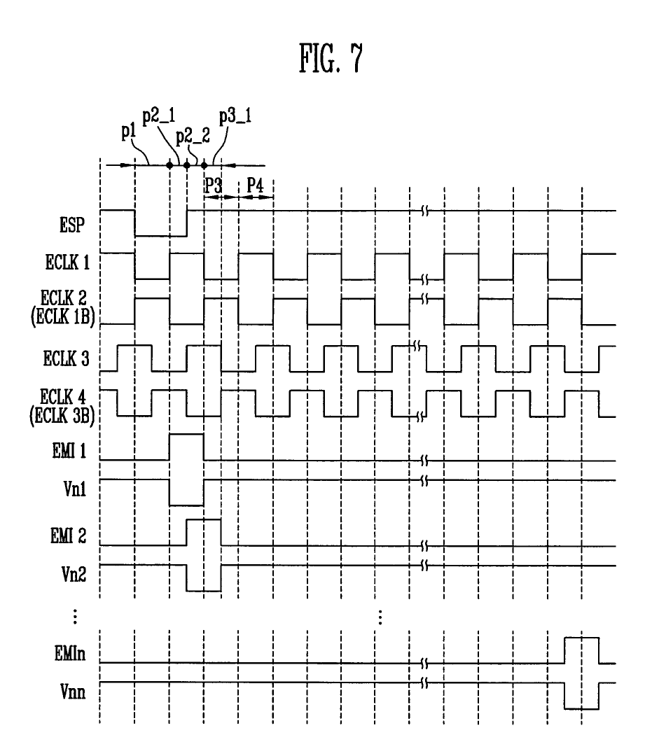

FIG. 6 illustrates a circuit diagram of an exemplary embodiment of a stage ST′i of the emission control driver 130 of FIG. 5. For convenience, FIG. 6 illustrates one example of the stage ST′i configured of one type of transistor, e.g., P-type transistors PMOS, and capacitors. However, embodiments are not limited thereto.

Referring to FIG. 6, the stage ST′1 may include a first voltage level controller 610, a second voltage level controller 620, a third voltage level controller 630, first and second transistors T1, T2, and a second capacitor C2′.

The first voltage level controller 610 may control a voltage level of a first node N1, corresponding to an output terminal of the first voltage level controller 610, based on an emission start pulse ESP or a first output signal Vin-1 of a previous stage and the first and second emission clock signals ECLK1 and ECLK2. The second voltage level controller 620 may control a voltage level of a second node N2 based on a voltage level of the first node N1 and the emission first clock signal ECLK1. The third voltage level controller 630 may control a voltage level of a third node N3, corresponding to an output terminal of the third voltage level control 630, based on voltage levels of the first and second nodes N1, N2. The first transistor T1 may control a voltage level of a fourth node N4 based on a voltage level of the third node N3. The second transistor T2 may control a voltage level of the fourth node N4 based on a voltage level of the second node N2.

The third node N3 and the fourth node N4 may correspond to output nodes of the stage ST′i. More specifically, the third node N3 may correspond to a first output terminal of the stage ST′I and the fourth node N4 may correspond to a second output terminal of the stage ST′1. The third node N3 may supply a first output signal Vni. The third node N3 may be coupled to an input line of a next stage ST′i+1 to supply the first output signal Vni to the next stage ST′i+1. The fourth node N4 may supply an emission control signal EMI. The fourth node N4 may be coupled to an emission control line Ei and may supply an emission control signal EMIi thereto.

The first voltage level controller 610 may include third and fourth transistors T3, T4 coupled between input lines of the first driving power EVDD source and the second emission clock signal ECLK2 in series.

The third transistor T3 may be coupled between the first driving power EVDD source and the first node N1. A gate electrode of the third transistor T3 may be coupled to an input line of the first emission clock signal ECLK1. The third transistor T3 may be a P-type transistor and, in such cases, may be turned on when the first emission clock signal ECLK1 has a low level voltage value. When the third transistor T3 is turned on, the first driving power EVVD source may be coupled to the first node N1.

The fourth transistor T4 may be coupled between the first node N1 and an input line of the second emission clock signal ECLK2. A gate electrode of the fourth transistor T4 may be coupled to the emission start pulse ESP or an input line of the first output signal Vni-1 of the previous stage ST′i−1. The fourth transistor T4 may be a P-type transistor and, in such cases, may be turned on when the emission start pulse ESP or the first output signal Vni-1 of the previous stage ST′i−1 has a low level voltage value. When the fourth transistor T4 is turned on, the first node N1 may be charged with a voltage value corresponding to a voltage level of the second emission clock signal ECLK2.

The second voltage level controller 620 may include fifth and sixth transistors T5, T6 coupled between the first driving power EVDD source and the second driving power EVSS source in series. A voltage of the second driving power EVSS source is set to be lower than voltage of the first driving power EVDD source.

The fifth transistor T5 may be coupled between the first driving power EVDD source and the second node N2. A gate electrode of the fifth transistor T5 may be coupled to the first node N1. The fifth transistor T5 may be a P-type transistor and, in such cases, may be turned on when a voltage level of the first node N1 is at a low level. When the fifth transistor T5 is turned on, the first driving power EVDD source may be electrically coupled to the second node N2.

The sixth transistor T6 may be coupled between the second node N2 and the second driving power EVSS source. A gate electrode of the sixth transistor T6 may be coupled to an input line of the first emission clock signal ECLK1. The sixth transistor T6 may be a P-type transistor and, in such cases, may be turned on when the first emission clock signal ECLK1 has a low level voltage value. When the sixth transistor is turned on, the second node N2 may be electrically coupled to the second driving power EVSS source.

The third voltage level controller 630 may include seventh and eighth transistors T7, T8 coupled between the first driving power EVDD source and the second driving power EVSS source in series.

The seventh transistor T7 may be coupled between the first driving power EVDD source and the third node N3. A gate electrode of the seventh transistor T7 may be coupled to the second node N2. The seventh transistor T7 may be a P-type transistor and, in such cases, may be turned on when a voltage level of the second node N2 is at a low level. When the seventh transistor T7 is turned on, the first driving power EVDD source may be electrically coupled to the third node N3.

In other words, in embodiments, when the seventh transistor T7 is turned on, the third node N3 may have a high-level voltage value. More particularly, when the seventh transistor T7 is turned on, a first output signal Vni having a high level voltage may be supplied to the input line of the next stage ST′i+1 coupled to the third node N3, i.e., the first output terminal of the stage ST′i.

The eighth transistor T8 may be coupled between the third node N3 and the second driving power EVSS source. A gate electrode of the eighth transistor T8 may be coupled to the first node N1. The eighth transistor T8 may be a P-type transistor and, in such cases, may be turned on when a voltage level of the first node N1 is at a low level. When the eighth transistor T8 is turned on, the third node N3 may be electrically coupled to the second driving power EVSS source.

In other words, in embodiments, when the eighth transistor T8 is turned on, the third node N3 may have a low-level voltage value. More particularly, when the seventh transistor T7 is turned on, a first output signal Vni having a low level voltage may be supplied to the input line of the next stage ST′i+1 coupled to the third node N3, i.e., the first output terminal of the stage ST′i.

The first transistor T1 may be coupled between the first driving power EVDD source and the fourth node N4. A gate electrode of the first transistor T1 may be coupled to the third node N3. The first transistor T1 may be a P-type transistor and, in such cases, may be turned on when a voltage level of the third node N3 is at a low level. When the first transistor T1 is turned on, the fourth node N4 may be electrically coupled to the first driving power EVDD source. In other words, in embodiments, when the first transistor T1 is turned on, the fourth node N4 may be charged with a high-level voltage value corresponding to the first driving power EVDD source. Therefore, when the first transistor T1 is turned on, the fourth node N4, i.e., the second output node of the stage ST′I, may be charged with a high-level voltage value. Thereby, a high-level emission control signal EMIi may be supplied to the emission control line Ei coupled to the fourth node N4.

The second transistor T2 may be coupled between the fourth node N4 and the second driving power EVSS source. A gate electrode of the second transistor T2 may be coupled to the second node N2. The second transistor T2 may be a P-type transistor and, in such cases, may be turned on when a voltage level of the second node N2 is at a low level. When the second transistor T2 is turned on, the fourth node N4 may be electrically coupled to the second driving power EVSS source. In other words, when the second transistor T2 is turned on, the fourth node N4 may be charged with a low-level voltage value corresponding to the second driving power EVSS source. Therefore, when the second transistor T2 is turned on, the fourth node N4 may be charged with a low-level voltage value. Thereby, a low-level emission control signal EMIi may be supplied to the emission control line Ei coupled to the fourth node N4.

Referring to FIG. 6, the stage ST′i may include a first capacitor C1′ coupled between the emission start pulse ESP or the first output signal Vni-1 of the previous stage ST′i−1 and the first node N1. The first capacitor C1′ may be included in the first voltage level controller 610. A first terminal of the first capacitor C1′ may be coupled to the gate electrode of the fourth transistor T4 and a second terminal of the first capacitor C1′ may be coupled to the source electrode of the fourth transistor T4. The first capacitor C1′ may stabilize a voltage between the gate electrode and the source electrode of the fourth transistor T4, and may enable the fourth transistor T4 to be stably operated.

Referring to FIG. 6, the second capacitor C2′ may be coupled between the second node N2 and the fourth node N4. A first terminal of the second capacitor C2′ may be coupled to the gate electrode of the second transistor T2 and a second terminal of the second capacitor C2′ may be coupled to the source electrode of the second transistor T2, and may enable the second transistor T2 to be stably operated.

In other words, in embodiments, the first and second capacitors C1′, C2′ may be provided to enable a more stable operation. However, embodiments are not limited thereto. For example, in embodiments, the first and/or the second capacitors C1′, C2′ may be omitted.

In the exemplary embodiment of the stage ST′i illustrated in FIG. 6, all of the transistors, e.g., T1 to T8 included in the stage ST′i are of a same type, e.g., P-type transistors By designing the stage ST′i to include transistors of one type, it is possible to simplify a manufacturing process thereof. However, embodiments are not limited thereto.

Referring to FIG. 1 and FIG. 5, when the emission control driver 130 receives the driving signals and the driving powers from the plurality of input terminals, e.g., inp1 to inp4, delay and/or voltage drop of the driving signals and the driving powers may be prevented and/or reduced. More particularly, e.g., by enabling the driving signals and the driving powers to be supplied from different directions to different portions of the emission control driver 130, delay and/or voltage drop of the driving signals and the driving powers may be prevented and/or reduced. Thus, in embodiments including, e.g., the stage ST′i of FIG. 6, the stage ST′i may be stably operated.

Hereinafter, an exemplary operation of the stage of FIGS. 5 and 6 will be described in detail in association with waveforms of input/output signals of FIG. 7. FIG. 7 illustrates a waveform diagram of exemplary input/output signals employable by the stage of FIG. 6. For convenience, elements such as threshold voltage of transistors will not be considered.

Referring to FIG. 7, during a first period p1, the emission start pulse ESP having a low level, the first emission clock signal ECLK1 having a low level and the second emission clock signal ECLK2 having a high level may be supplied to the first stage ST′1. Herein, it will be assumed that a circuit constitution of the first stage ST′1 is the same as that of the ith stage ST′i of FIG. 6.

During the first period p1, the third transistor T3 and the sixth transistor T6 may be turned on corresponding to the low-level of the first emission clock signal ECLK 1, and the fourth transistor T4 may be turned on corresponding to the low-level of the emission start pulse ESP.

When the third and fourth transistors T3, T4 are turned on, the first node N1 may be electrically coupled to the input lines of the first driving power EVDD source and the second emission clock signal ECLK2. Referring to FIG. 7, during the first period, the voltage levels of first driving power EVDD source and the second emission clock signal ECLK2 are at a high-level so the first node N1 may be charged with a high-level voltage.

When the sixth transistor T6 is turned on, the second node N2 may be electrically coupled to second driving power EVSS source. In such cases, the second node N2 may be charged with a low-level voltage.

When the first node N1 is charged with the high-level voltage, the fifth transistor T5 and the eighth transistor T8 may be turned off.

When the second node N2 is charged with the low-level voltage via, e.g., the on state of the sixth transistor T6, the seventh transistor T7 and the second transistor T2 may be turned on.

When the seventh transistor T7 is turned on, the first driving power EVDD source and the third node N3 may be electrically coupled and the third node N3 may be charged with the high-level voltage of the first driving power EVDD source. Therefore, the first transistor T1 may be turned off and a first output signal Vn1 having a high level voltage may be supplied to an input line of a next stage, e.g., input line of the second stage ST′2, from the third node N3, i.e., a first output node of the stage ST′1.

When the second transistor T2 is turned on, the fourth node N4, i.e., a second output node of the stage ST′1, may be electrically coupled to the second driving power EVSS source. Thereby, a low-level emission control signal EMI1 may be supplied to a first emission control line El from the fourth node N4.

During a first portion of a second period T2_1, the emission start pulse ESP having a low level, the first emission clock signal ECLK1 having a high level and the second emission clock signal ECLK2 having a low level may be supplied to the first stage ST′1.

During the first portion of the second period T2_1, the third transistor T3 and the sixth transistor T6 may be turned off corresponding to the high-level of the first emission clock signal ECLK1.

The fourth transistor T4 may be turned on corresponding to the low-level of the emission start pulse ESP. When the fourth transistor T4 is on, the low-level voltage corresponding to the state of the second emission clock signal ECLK2 during the first portion of the second period p2_1 may be transferred to the first node N1. Thereby, during the first portion of the second period p2_1, the first node N1 may be charged with the low-level voltage.

When the first node N1 is charged with the low-level voltage via, e.g., the on state of the fourth transistor T4 and the low level of the second emission clock signal ECLK2, the fifth transistor T5 and the eighth transistor T8 may be turned on. Thereby, the second node N2 may be charged with the high-level voltage of the first driving power EVDD source, and the third node N3 may be charged with the low-level voltage of the second driving power EVSS source.

As the second node N2 is charged with the high-level voltage via, e.g., the on state of the fifth transistor T5, the seventh transistor T7 and the second transistor T2 may be turned off.

Meanwhile, as the third node N3 is charged with the low-level voltage via, e.g., the eighth transistor T8, the first transistor T1 may be turned on so that the fourth node N4 may be charged with the high-level voltage of the first driving voltage EVDD source. In such cases, the high-level emission control signal EMI1 may be supplied to the first emission control line E1 coupled to the fourth node N4. Also, the low-level first output signal Vn1 may be supplied to the input line of the next stage, e.g., the second stage ST′2, coupled to the third node N3 of the first stage ST′1.

During a second portion of the second period p2_2, the emission start pulse ESP having a high level, the first emission clock signal ECLK1 having a high level and the second emission start clock ECLK2 having a low level may be supplied to the first stage ST′1.

During the second portion of the second period p2_2, the third, fourth and sixth transistors T3, T4, T6 may turn off corresponding to the high-level of the emission start pulse ESP and the first emission clock signal ECLK1 and may maintain a previous state, e.g., a state thereof during the corresponding first portion of the second period p2_1. Therefore, the first emission control signal EMI1 having a high level and the first output signal Vn1 having a low level may be output to the input lines of the first emission control line E1 and the next stage (that is, the second stage, ST′2), respectively, even during the p2_2 period likewise the p2_1 period.

During a third period p3, the emission start pulse ESP may have a high level, the first emission clock signal ECLK1 may have a low level and the second emission clock signal ECLK2 may have a high level.

During the third period p3, the fourth transistor T4 may be turned off corresponding to the high-level of the emission start pulse ESP, and the third transistor T3 and the sixth transistor T6 may be turned on corresponding to the low-level of the first emission clock signal ECLK1.

When the third transistor T3 is turned on, the first node N1 may be charged with the high-level voltage of the first driving power EVDD source. When the first node is charged with a high-level voltage, the fifth transistor T5 and the eighth transistor T5, T8 may be turned off. When the sixth transistor T6 is turned on, the second node N2 may be charged with the low-level voltage of the second driving power EVSS source.

As the second node N2 is charged with the low-level voltage, the seventh transistor T7 and the second transistors T2 may be turned on.

When the seventh transistor T7 is turned on, the third node N3 may be charged with the high-level voltage of the first driving power EVDD source. Thereby, the first transistor TI may be turned off and a first output signal Vn1 having a high level may be output to the input line of the next stage (e.g., the second stage, ST′2).

When the second transistor T2 is turned on, the fourth node N4 may be charged with the low-level voltage of the second driving power EVSS source. Thereby, a first emission control signal EMI1 having a low-level may be output to the first emission control line E1 coupled to the fourth node N4.

During a fourth period p4, the emission start pulse ESP may have a high level, the first emission clock signal ECLK1 may have a high level and the second emission clock signal ECLK2 may have low level.

During the fourth period p4, the third, fourth and sixth transistors T3, T4, T6 may be turned off corresponding to the high-level emission start pulse ESP and the first emission clock signal ECLK1. In such cases, the first node N1 may maintain the level it had during the third period p3, i.e., maintain a high level and the fifth and eighth transistors T5 and T8 may remain off. With the high level of the first emission clock signal ECLK1, the sixth transistor T6 may be turned off, and the second node N2 may maintain the level it had during the third period p3. In such cases, output terminals of the stage ST′I may maintain levels they had during a previous period, e.g., during the third period p3. That is, the first emission control signal EMI1 may have a low level and the first output signal Vn1 may have a high level. More particularly, the first emission control signal EMI having a low level may be output to the input line of the first emission control line E1 and the first output signal Vn1 having a high level may be output the input line of the next stage, e.g., the second stage, ST′2.

During subsequent periods, the same signals as those supplied during the third period p3 and the fourth period p4 may be repeatedly supplied to the first stage ST′1. Thereby, the voltage level of the first emission control signal EMI1 may be maintained at a low-level, and the voltage level of the first output signal Vn1 may be maintained at a high level during the subsequent periods.

As described above, the second stage ST′2 may receive the first output signal Vn1 of the first stage ST′1. The second stage ST′2 may output the first output signal Vn1 from the first stage ST′1, phase delayed by, e.g., ½ a clock cycle or a ¼ period of a clock signal, based on the first output signal Vn1 from the first stage ST′1 instead of the emission start pulse ESP, and the third and fourth emission clock signals ECLK3, ECLK4.

More specifically, during the p2_1 period, the second stage ST′2 may output a second emission control signal EMI2 having a low level and a first output signal Vn2 having a high-level based on the first output signal Vn1 of the first stage ST′1 having a low level, the third emission clock signal ECLK3 having a low level and the fourth emission clock signal ECLK4 having a high level. In embodiments, operation of the second stage ST′2 during the p2_1 period may be the same as the operation of the first stage ST′1 during the p1 period, so a detailed description thereof will be omitted.

Thereafter, during the p2_2 period, the second stage ST′2 may output a second emission control signal EMI2 having a high level and a first output signal Vn2 having a low-level based on the first output signal Vn1 of the first stage ST′1 having a low level, the third emission clock signal ECLK3 having a high level and the fourth emission clock signal ECLK4 having a low-level. In embodiments, operation of the second stage ST′2 during the p2_2 period may be the same as the operation of the first stage ST′1 during the p2_1 period, so a detailed description thereof will be omitted.

Thereafter, during the p3_1 period, the second stage ST′2 outputs a high-level second emission control signal EMI2 and a first output signal Vn2 of the low-level second stage ST′2 corresponding to the first output signal Vn1 of the high-level first stage ST′1, the high-level ECLK3 and the low-level ECLK4. Herein, an operation of the second stage ST′2 during the p3_1 period is the same as the operation of the first stage ST′1 during the p2_2 period so that the detailed description thereof will be omitted.

Thereafter, during subsequent periods, the second stage ST′2 may operate in the same manner that the first stage ST′1 operates during the third period p3 and the fourth period p4. For example, in embodiments, a voltage level of the second emission control signal EMI2 output from the second stage ST′2 may be maintained at a low level and the voltage level of the first output signal Vn2 of the second stage ST′2 may be maintained at a high level during the subsequent periods.

In embodiments, the stages ST′i of the emission control driver 130 may output a phase delayed first output signal Vni (or, emission start pulse ESP) of a previous stage ST′i−1 based on the first and second emission clock signals ECLK1, ECLK2 and/or the third and fourth emission clock signals ECLK3 and ECLK4. The phase delay may be, e.g., ½ a clock or ¼ of a period of the clock signal. receive the first output signal Vn1 of the first stage ST′1. The stages ST′i may also output an emission control signal EMIi, and the emission control signal EMI may correspond to an inverse of the first output signal Vni output by the respective stage ST′i.

Exemplary embodiments of aspects of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emitting display device, comprising:
a pixel unit including scan lines, data lines and a plurality of pixels positioned at intersecting portions of the scan lines and the data lines and electrically coupled therebetween;
a driver adapted to supply driving signals to the pixel unit; and
a plurality of pads,
wherein the plurality of pads are adapted to supply driving powers and/or driving signals to the pixel unit and the driver, and the plurality of pads include a first subset of pads adapted to supply the same driving power and/or the same driving signal to the driver.

2. The organic light emitting display device as claimed in claim 1, further comprising a plurality of input terminals, each of the input terminals including at least one pad of the first subset of pads supplying the same power and/or the same driving signal to the driver, the driver being coupled to at least two of the plurality of input terminals.

3. The organic light emitting display device as claimed in claim 2, wherein the driver comprises a plurality of stages cascadingly coupled to an input pad of a start pulse and is adapted to sequentially generate the driving signals, at least one of the plurality of input terminals is coupled to a first stage and at least another of the plurality input terminals is coupled to a last stage among the plurality of stages of the driver.

4. The organic light emitting display device as claimed in claim 3, wherein other input terminals of the plurality of input terminals are coupled between intermediate stages arranged between the first stage and the last stage.

5. The organic light emitting display device as claimed in claim 4, wherein the input terminals of the plurality of input terminals coupled between intermediate stages are coupled directly between two of the stages and are arranged to be substantially evenly dispersed among the stages.

6. The organic light emitting display device as claimed in claim 3, wherein the at least one input terminal coupled to the first stage is coupled directly to the first stage relative to the others of the plurality of stages and the at least one input terminal coupled to the last stage is coupled directly to the last stage relative to the others of the plurality of stages.

7. The organic light emitting display device as claimed in claim 1, wherein the pixel unit and the driver are on one panel.

8. The organic light emitting display device as claimed in claim 7, wherein the plurality of input terminals of the driver are dispersed among at least two different edges of the panel so that the driving powers and the driving signals are supplied to the driver from at least two different directions.

9. The organic light emitting display device as claimed in claim 2, wherein the driving powers and the driving signals supplied to the driver from the plurality of input terminals include first and second powers of the driver and clock signals.

10. The organic light emitting display device as claimed in claim 1, wherein the driver includes P-type transistors and capacitors.

11. The organic light emitting display device as claimed in claim 1, wherein the pixel unit further comprises emission control lines coupled to the pixels and the driver is an emission control driver adapted to supply emission control signals to the emission control lines.

12. The organic light emitting display device as claimed in claim 1, wherein the driver is a scan driver adapted to supply scan signals to the scan lines.

13. The organic light emitting display device as claimed in claim 1, further comprising a plurality of input terminals including a first subset and a second subset of input terminals, and the plurality of pads including a second subset of pads,
wherein:
the driver includes a scan driver adapted to supply scan signals to the scan lines and an emission control driver adapted to supply emission control signals to emission control lines of the pixel unit,
the first subset of pads are adapted to supply the same power and/or the same driving signal to the scan driver, the scan driver is coupled to the first subset of input terminals, each of the first subset of input terminals including at least one pad of the first subset of pads, and
the second subset of pads are adapted to supply a same driving power and/or a same driving signal to the emission control driver, the emission control driver is coupled to the second subset of input terminals, each of the second subset of input terminals including at least one pad of the second subset of pads.

14. The organic light emitting display device as claimed in claim 13, wherein:
each of the scan driver and the emission control driver includes a plurality of stages cascadingly coupled,
the plurality of stages of the scan driver being coupled to an input pad of a scan start pulse and adapted to sequentially generate and supply the driving signals to the scan lines, and
the plurality of stages of the emission control driver being coupled to an input pad of an emission start pulse and adapted to sequentially generate and supply the emission control signals to the emission control lines.

15. The organic light emitting display device as claimed in claim 14, wherein one input terminal of the first subset of input terminals is coupled to a first stage of the scan driver and at least another of the input terminal of the first subset of input terminals is coupled to a last stage among the plurality of stages of the scan driver, and
one input terminal of the second subset of input terminals is coupled to a first stage of the emission control driver and at least another input terminal of the second subset of input terminals is coupled to a last stage among the plurality of stages of the emission control driver.

16. The organic light emitting display device as claimed in claim 15, wherein other input terminals of each of the first subset and the second subset of input terminals are coupled between intermediate stages arranged between the first stage and the last stage of the scan driver and the emission control driver, respectively.

17. The organic light emitting display device as claimed in claim 13, wherein the driving powers and the driving signals supplied to the scan driver from the first subset of input terminals include first and second driving powers and scan clock signals, and the driving powers and the driving signals supplied to the emission control driver from the second subset of input terminals include first and second driving powers and emission clock signals.

18. The organic light emitting display device as claimed in claim 13, wherein the pixel unit, the scan driver and the emission control driver are on one panel.

19. The organic light emitting display device as claimed in claim 18, wherein each of the first subset and the second subset of input terminals are dispersed among at least two different edges of the panel so that the respective driving powers and the respective driving signals are respectively supplied to the scan driver and the emission control driver from at least two different directions.

20. An organic light emitting display device, comprising:
a pixel unit including a plurality of data and control signal lines, the pixel unit including a plurality of pixels at intersecting portions of the respective data and control signal lines;
a first control signal driver adapted to supply first control signals to respective ones of the control signal lines; and
a plurality of input terminals adapted to supply a first driving power and a first driving signal to the first control signal driver and the pixel unit,
wherein each of the input terminals include:
a pad adapted to supply the first driving power to the first control signal driver, and
a pad adapted to supply the first driving signals to the first control signal driver, wherein the input terminals are each coupled to a different portion of the first control signal driver.
